(19) United States
(12) Patent Application Publication
(10) Pub. No.: US 2007/0278751 A1
(43) Pub. Date: Dec. 6, 2007

(54) Support Apparatus

(76) Inventors: Allan Hay, Aberdeenshire (GB); Peter William Alexander Cowie, Aberdeenshire (GB)

Correspondence Address: KED & ASSOCIATES, LLP, P.O. Box 221200, Chantilly, VA, 20153-1200, US

(21) Appl. No.: 11/578,779

(22) PCT Filed: Apr. 19, 2005
(86) PCT No.: PCT/GB05/01515

§ 371 Date: Jul. 18, 2007

(30) Foreign Application Priority Data
Apr. 19, 2004 (GB) 0408643.5

(51) Int. Cl. B23B 31/10

(52) U.S. Cl. 279/2.19; 279/2.01

(57) ABSTRACT

An improved support apparatus for use in machining operations on centre lathes, milling, drilling and associated metalworking equipment found in engineering workshops. The support apparatus supports internally a component that is being worked on to prevent the component from being distorted by the gripping or clamping forces exerted by a chuck or clamping device. The support apparatus is capable of accommodating variations in component size, holding different shaped cross sections, and of being held by differing shapes of existing fixtures.

The present invention relates to a support apparatus, support plate or support bung for use in machining operations on centre lathes, milling, drilling and associated metalworking equipment found in engineering workshops. Support apparatus of these types are used to support internally a component that is being worked on to prevent the component from being distorted by the gripping or clamping forces exerted by a chuck or clamping device.

The most common problems encountered when gripping a hollow section component using either chucks, fixtures or mandrels are described below.

A hollow component such as a pipe can be distorted, such that it goes from having a substantially circular cross-sectional shape to having an oval cross-sectional shape. This can be caused by excessive chuck pressure being exerted on the component, or by the use of a badly fitting bung or support plate which leaves a diametrical gap between the support plate and the component diameter.

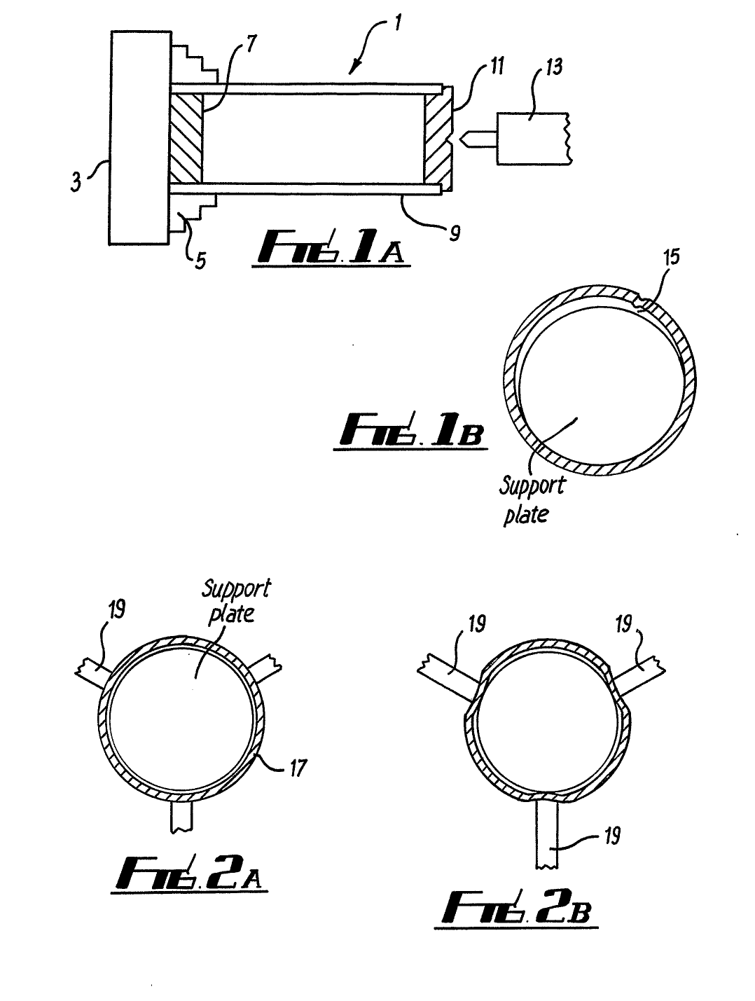

FIG. 1A shows an example of the prior art shown generally by reference numeral 1, having a chuck 3 with chuck jaws 5 and a chuck support plate 7. A first end of the component 9 is placed between the support plate 7 and the chuck jaws 5. A second support plate 11 is provided at the second end of the component, and has a recess capable of accepting a tail stock 13. FIG. 1B shows a situation where the support plate is mounted eccentrically within the component, and an eccentric gap 15 is shown which will cause deformation of the component.

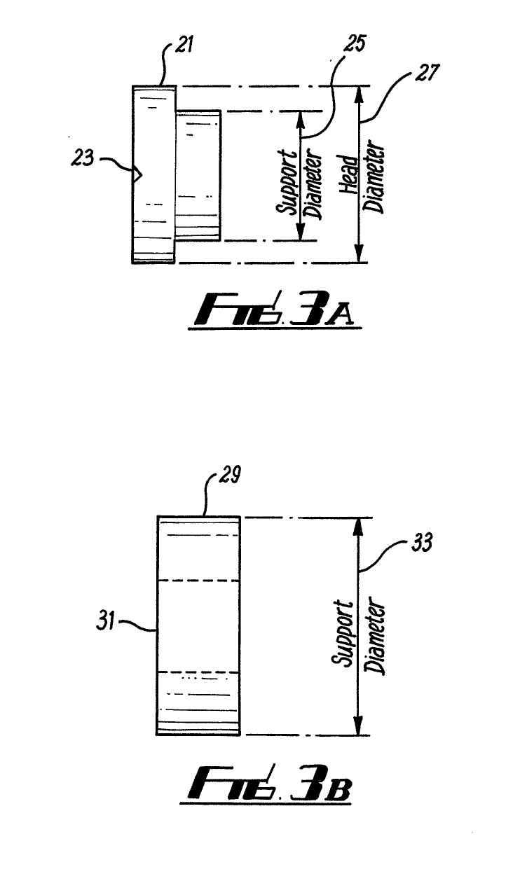

FIGS. 2A and 2B show deformations of a component that can occur where a support plate that is concentric with respect to the component is used, but where a concentric gap is present between the support plate and the component.

The concentric gaps can be caused by badly worn chuck jaws, a support plate centre not manufactured to suit component tolerances as shown in FIG. 2A, and a diametric difference between the component and the support plate, also shown in 2A.

FIG. 2B shows a component in which the problem of lobbing has occurred. This happens where excessive pressure has been exerted by the chuck jaws, leading to the permanent distortion of the component. It can also occur where a concentric or eccentric gap is present because of the use of a support plate with too small a diameter.

In addition, the surface finish of the component can be damaged due to abrasive cutting, noise vibration or ringing frequencies that occur where the support plate is too small.

In general, support plates are manufactured to a specific diameter. However, components are manufactured to within a tolerance, therefore, a diametrical gap will almost always occur where a solid support plate is used, resulting in the above problems. In order to be effective in their operation, support plates must have a maximum difference in diameter between the component and support plate of 0.1 mm. In order to adequately cover a dynamic range of 100 mm to 200 mm, a total of 1,000 support plates will be required to be manufactured, stored and serialised. The manufacture and management of the support plates are therefore extremely high.

FIGS. 3A and 3B show different styles of known support plates. FIG. 3A shows a standard support plate having a tail stock centre point 23, a support diameter 25 and a head diameter 27. FIG. 3B shows a support plate 29 having a centre hole 31 created in order to reduce the overall weight of the support plate. In addition, the support plate has a single diameter, which means that the entire support plate can be inserted into the component.

Due to the cost, storage and differing formats, support plates are manufactured to suit a specific application and in extreme cases, may be used only once and then discarded. Alternatively, inappropriate support plates are used which have not been designed for the specific dimensions of the components and their use results in the problems of overality, concentricity, lobbing and damage to the surface finish mentioned above. It should also be noted that for hollow components having square, rectangular, triangular or other cross-sectional profiles, the use of support plates is less common because of the high manufacturing costs.

It is an object of the present invention to provide an improved support apparatus.

In accordance with the first aspect of the present invention, there is provided a support apparatus for supporting a hollow part of a component being machined, the support apparatus comprising:

a mounting;

at least one support member connectable with a surface to be supported; and

an actuator for moving the at least one support member in a substantially radial direction with respect to a centre point on the support member to allow radial extension and contraction of the at least one support member.

Preferably, the actuator and the support member are contactable by a cam and a cam follower.

Preferably, the actuator comprises a rotably mounted member having a cam surface contactable with a cam follower surface on the support member.

Preferably, the cam surface is situated on the perimeter surface of the rotatably mounted member.

Optionally, the cam surface is provided by a recess in the rotatably mounted member.

Preferably, the actuator is provided with gear cogs which are couplable to a drive gear.

Preferably, the drive gear is a worm gear.

Optionally, the drive gear is a spur gear.

Preferably, the drive gear is removably couplable to the gear cogs.

In view of the above disclosure, it will be appreciated that the action of the cam surface and the cam follower is designed to provide radial movement of the support member.

Preferably the amount of radial extension of the support member can be set by providing locking means to inhibit the rotation of the drive gear when coupled to the gear cogs of the actuator.

Preferably the drive gear is mounted on a shaft between resilient means and a tapered end part.

Preferably the tapered end part is mateable with a recess in the mounting, such that when mated, rotation of the drive gear is inhibited.

Preferably the resilient means forms a release mechanism to allow the drive gear to be rotated upon compression of the resilient means.

Preferably the mounting support comprises a back plate and an actuator support.

Preferably the back plate is provided with vibration damping means.

Preferably the vibration damping means is provided by a pressure wave washer.

Preferably the back plate is provided with a recess for receiving the resilient means mounted on the shaft.

Preferably the support member is spring loaded to press against the surface to be supported.

Preferably the spring is a leaf spring.

Optionally the spring is a coil spring.

Preferably the support member is provided with a support surface shaped to conform with the surface to be supported.

Optionally the support surface is tapered.

Optionally the support surface is provided with a tapered hole.

Optionally the support surface is curved so as to contact the surface to be supported at a single point.

Preferably the support apparatus is further provided with a plurality of actuator mounting and support members arranging axially with respect to one another, and each having at least one support member.

The present invention will now be described by way of example only, with reference to the accompanying drawings, in which:

FIG. 1A is a side view of an example of prior art and FIG. 1B is a cross-sectional view of an example of prior art;

FIG. 2A is a cross-sectional view of a support plate used in a component in which the gap between these is illustrated and FIG. 2B is a cross-sectional view which shows the problem of lobbing in the prior art;

FIGS. 3A and 3B are side views of examples of prior art support plates;

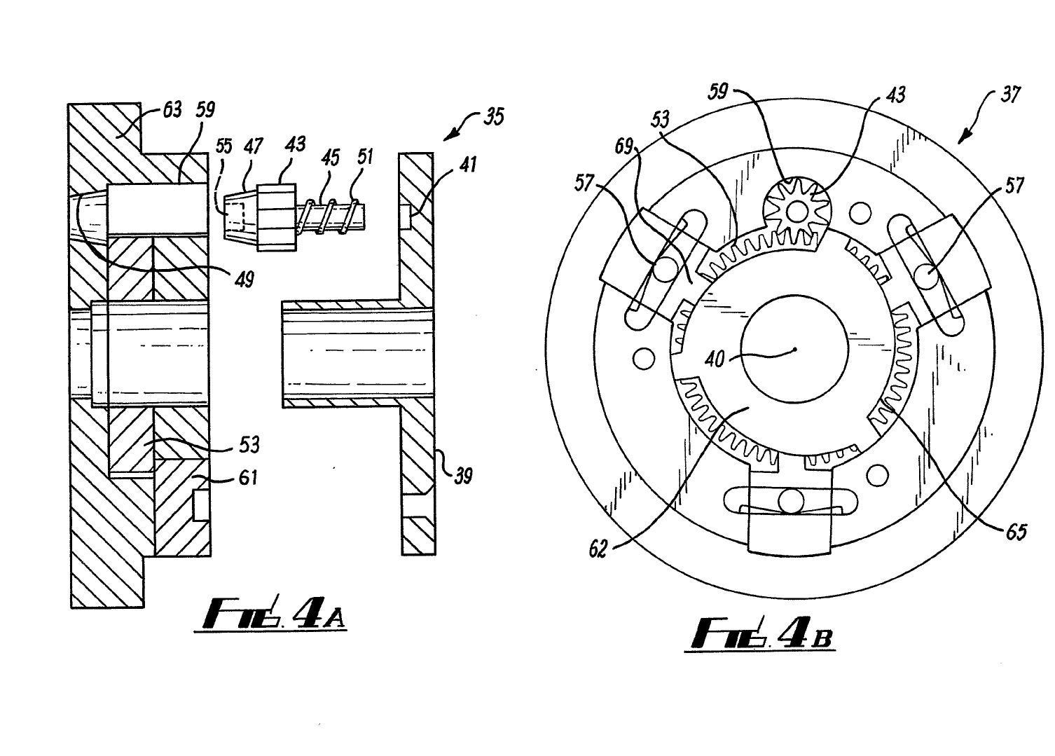

FIG. 4A is a cross-sectional side view of a first embodiment of the present invention, and FIG. 4B is an end view of the same embodiment;

FIG. 5 is a schematic side view of the embodiment of FIG. 4 showing the position of the keys or support members;

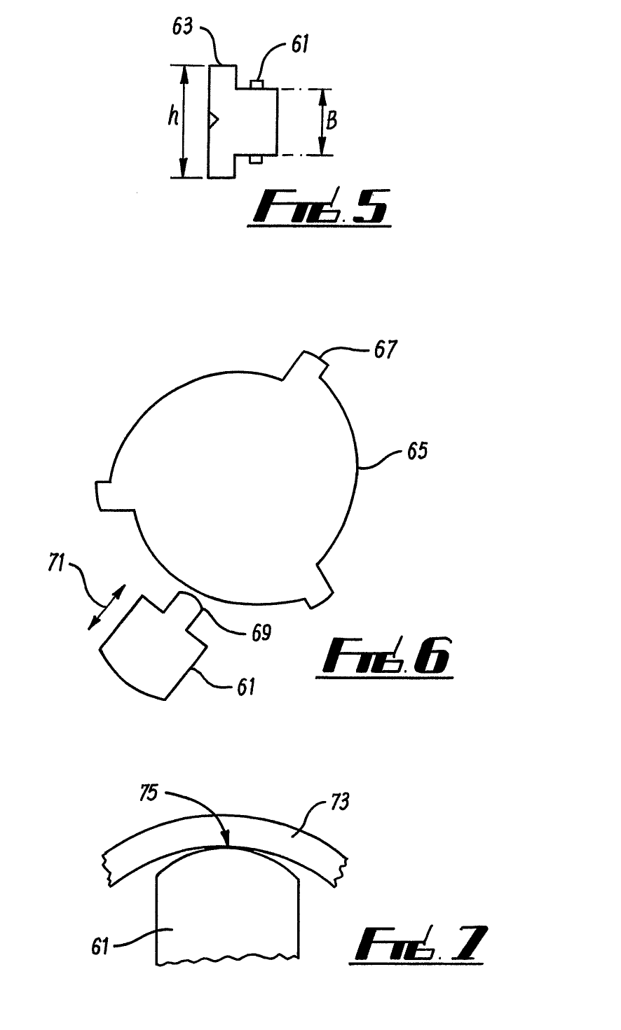

FIG. 6 shows a cam arrangement used in the embodiment of FIG. 4;

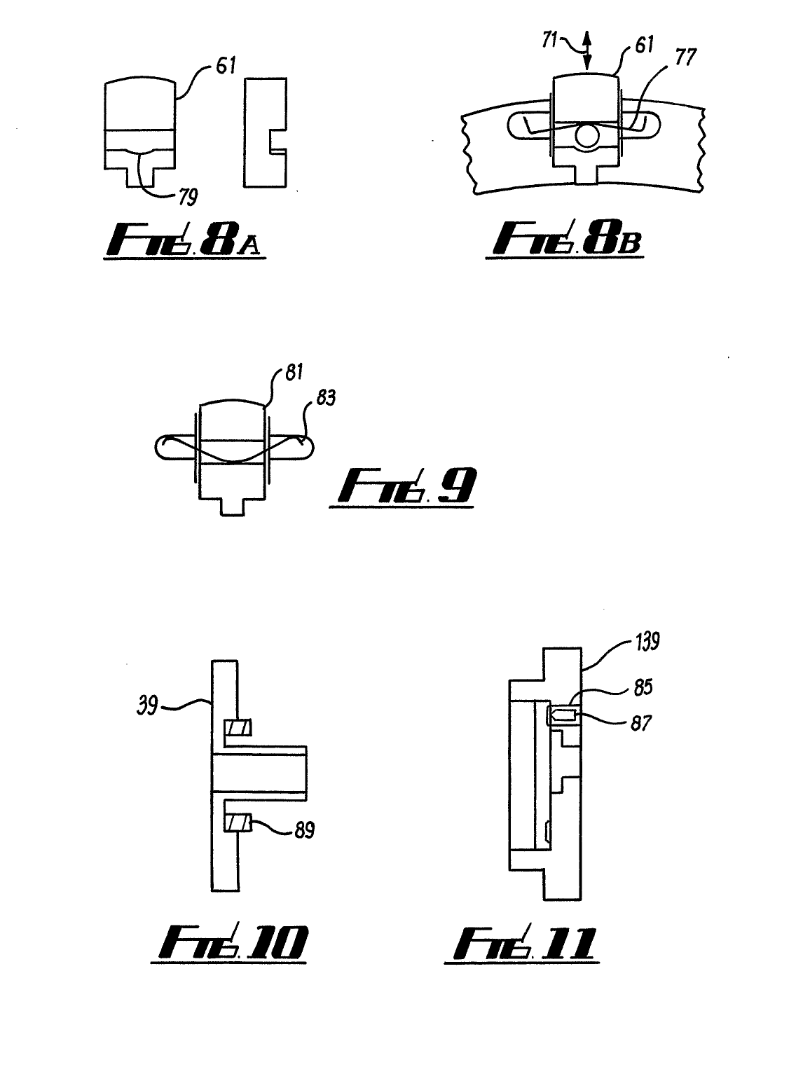

FIG. 7 shows the key or support member in contact with the supported component at a single point of contact;

FIG. 8A shows the support member or key provided with a coil spring recess, and FIG. 8B shows the recess or retaining pocket in which the spring is situated in use;

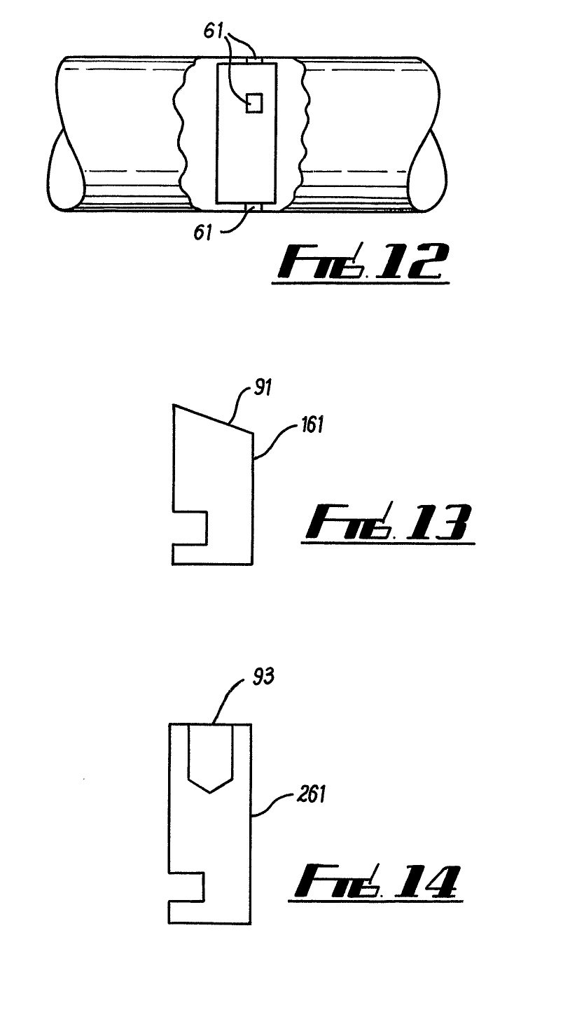

FIG. 9 shows the support member or key having a leaf spring;

FIG. 10 shows a back plate that is used in the present invention;

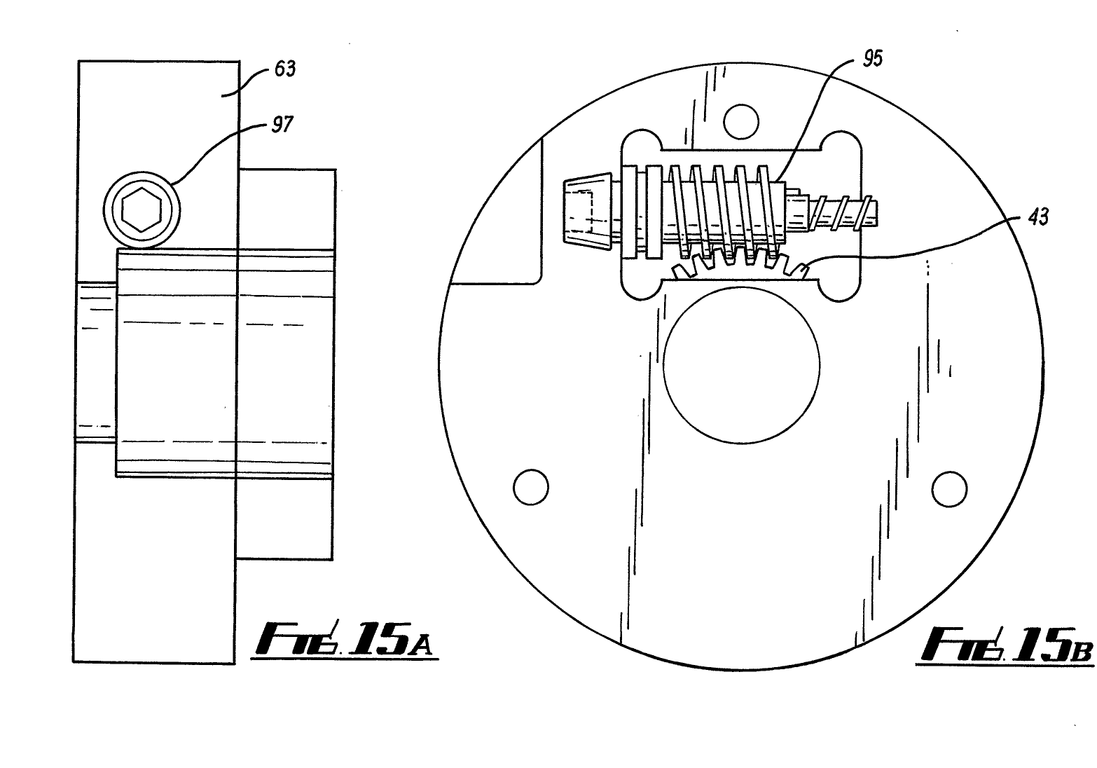

FIG. 11 shows a back plate having a locking grub screw;

FIG. 12 shows a support apparatus designed for use internally within a hollow component, such as a circular cross-section pipe;

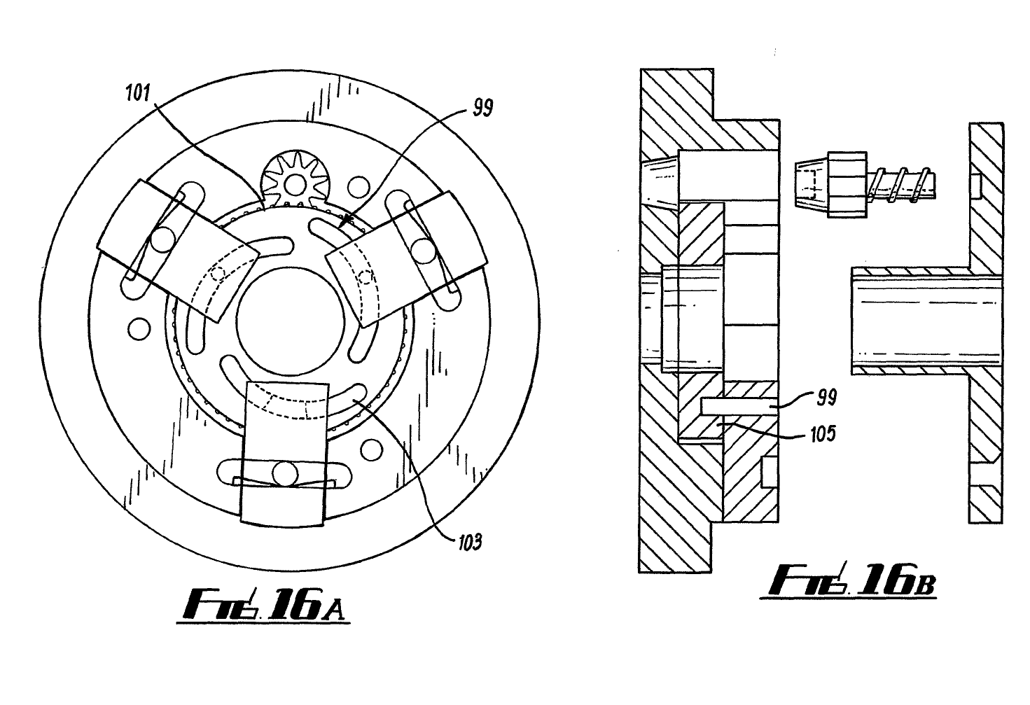

FIG. 13 shows a key or support member having a taper on the contact edge;

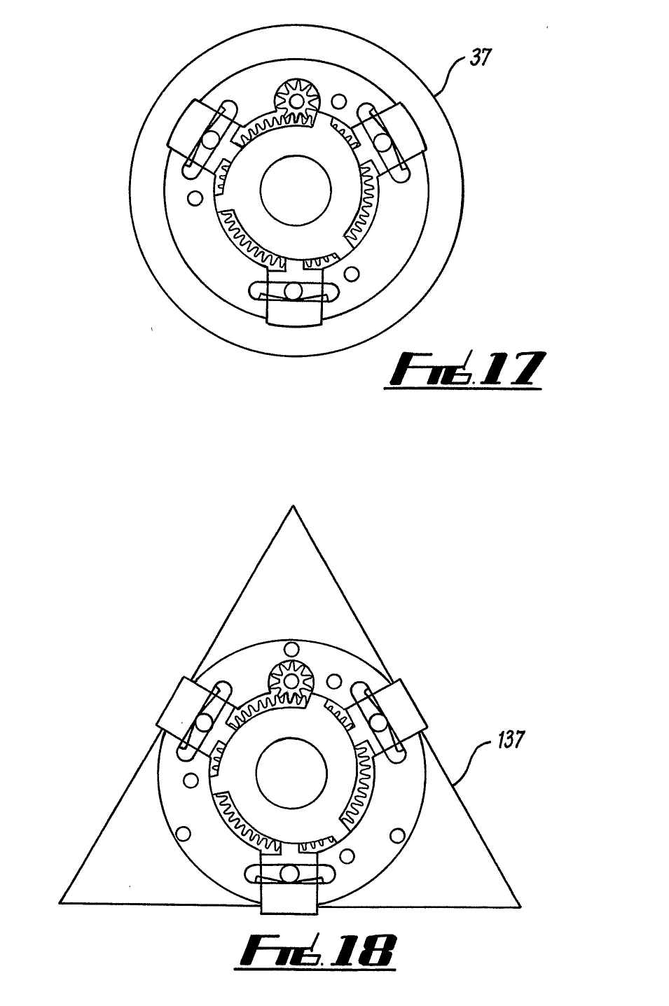

FIG. 14 shows a tapered hole on the key or support member, the tapered hole being used to accept a location pin on the contact edge;

FIG. 15A is a side view of a second embodiment of the present invention, and FIG. 15B is an end view showing the presence of a worm gear for operation of the cam mechanism;

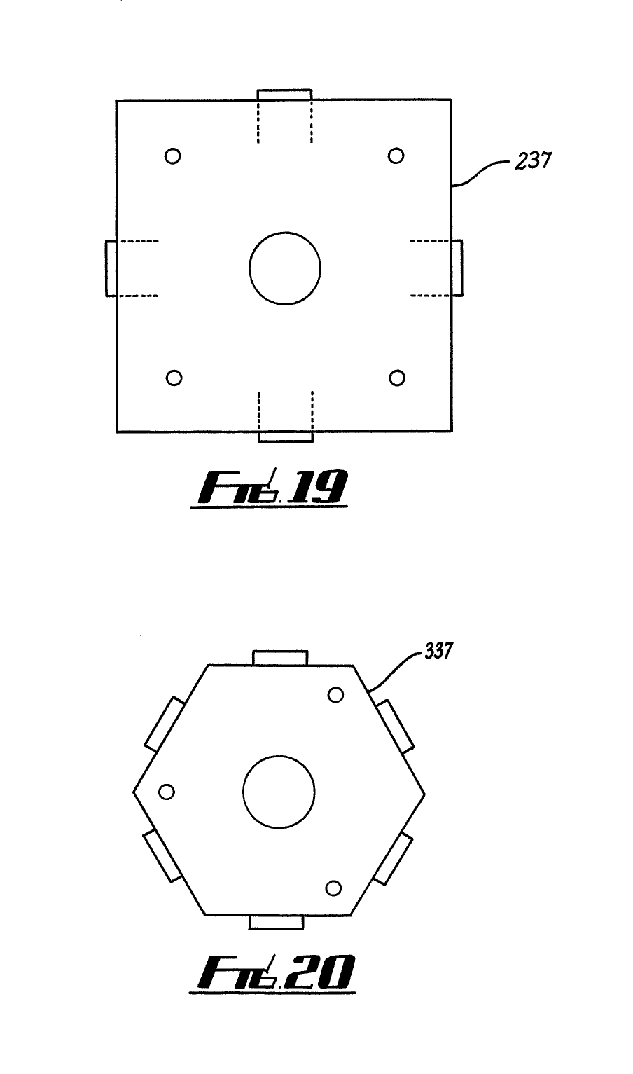

FIGS. 16A and 16B are end views and cross sectional views respectively of a third embodiment of the present invention;

FIG. 17 is an end view of the first embodiment of the present invention;

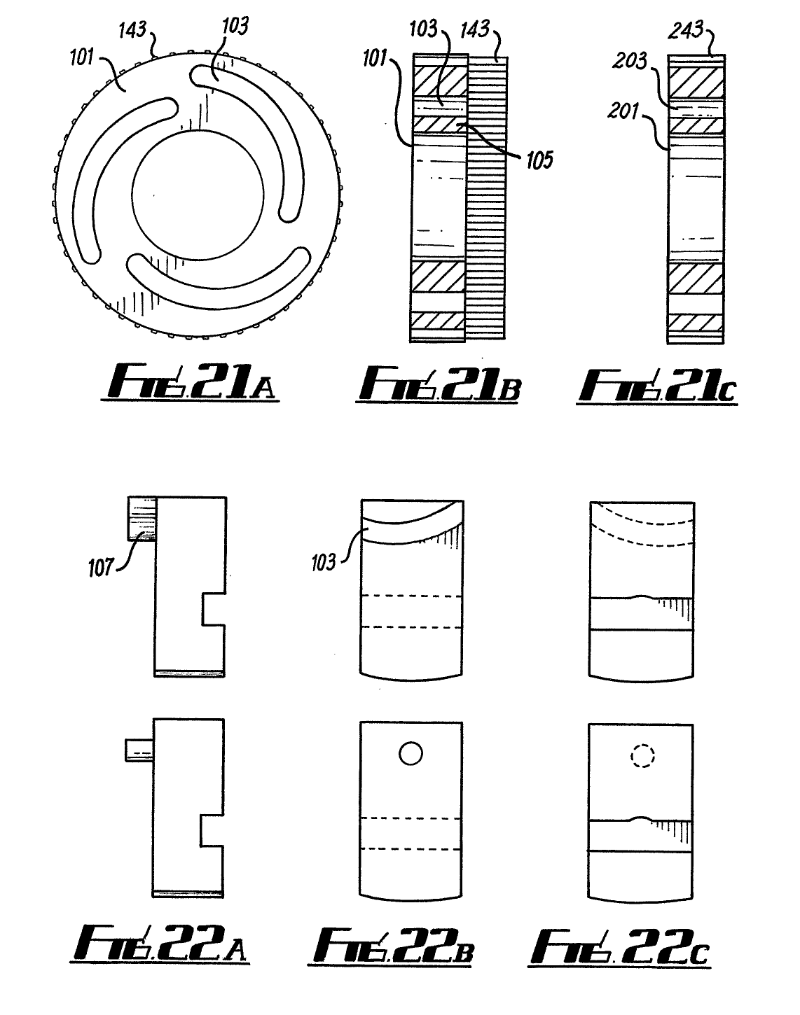

FIG. 18 is an end view of a fourth embodiment of the present invention;

FIG. 19 is an end view of a fifth embodiment of the present invention, having multiple cam wheel assemblies;

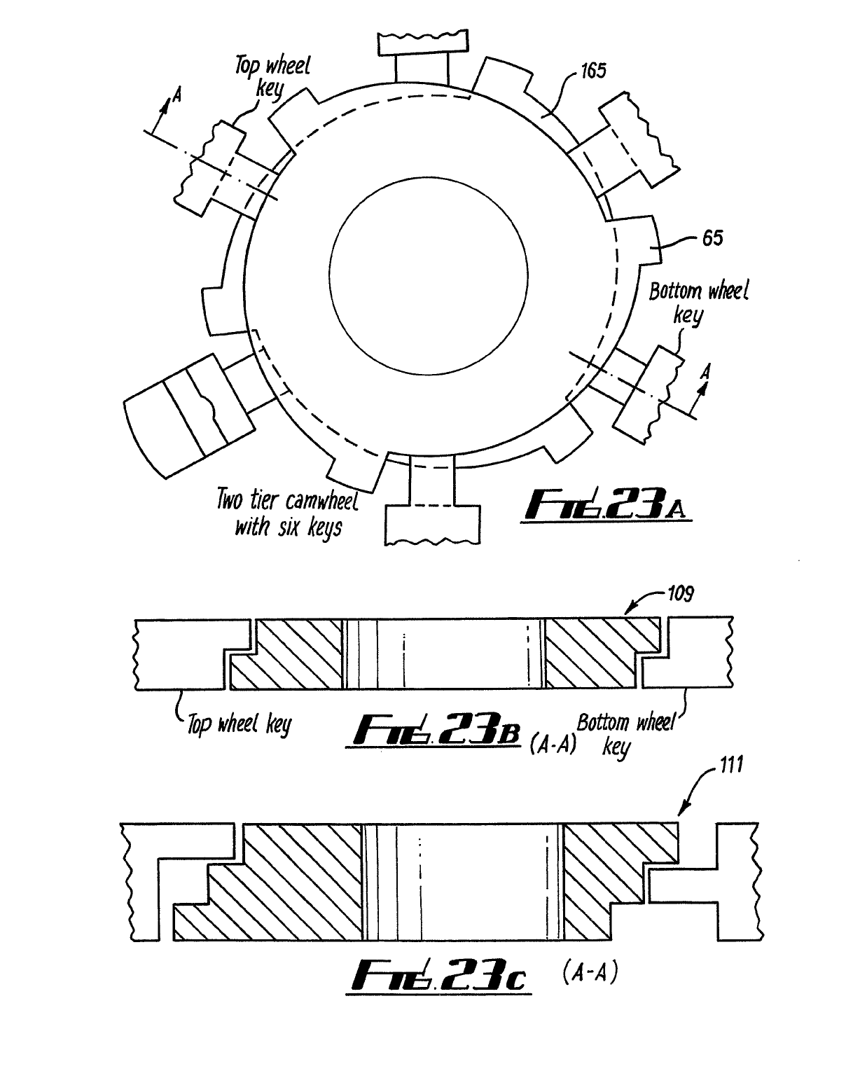

FIG. 20 is an end view of a sixth embodiment of the present invention, having multiple cam wheel assemblies;

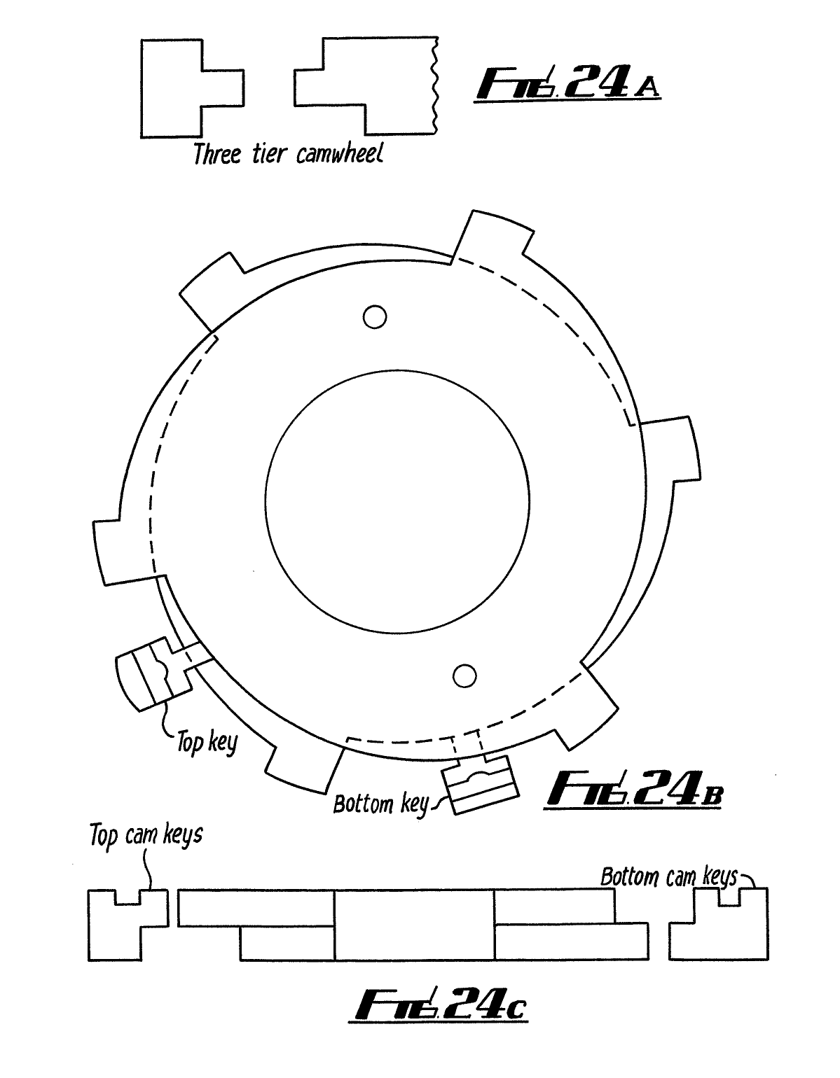

FIGS. 21A to 21C show an embodiment of a cam and gear arrangement used in the present invention;

FIGS. 22A to 22C provide details of cam followers used on the support member or key;

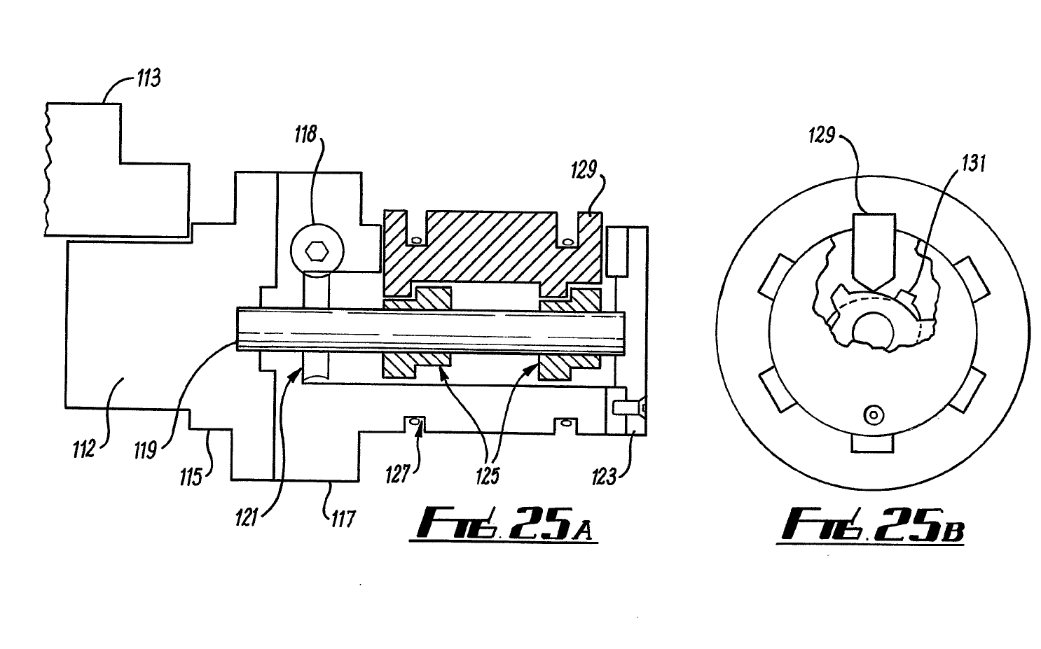

FIGS. 23A to 23C shows an embodiment of the present invention where two separate cam wheels with six support members or keys are provided;

FIG. 24A to 24C shows an embodiment of the present invention where three separate cam wheels with six support members or keys are provided;

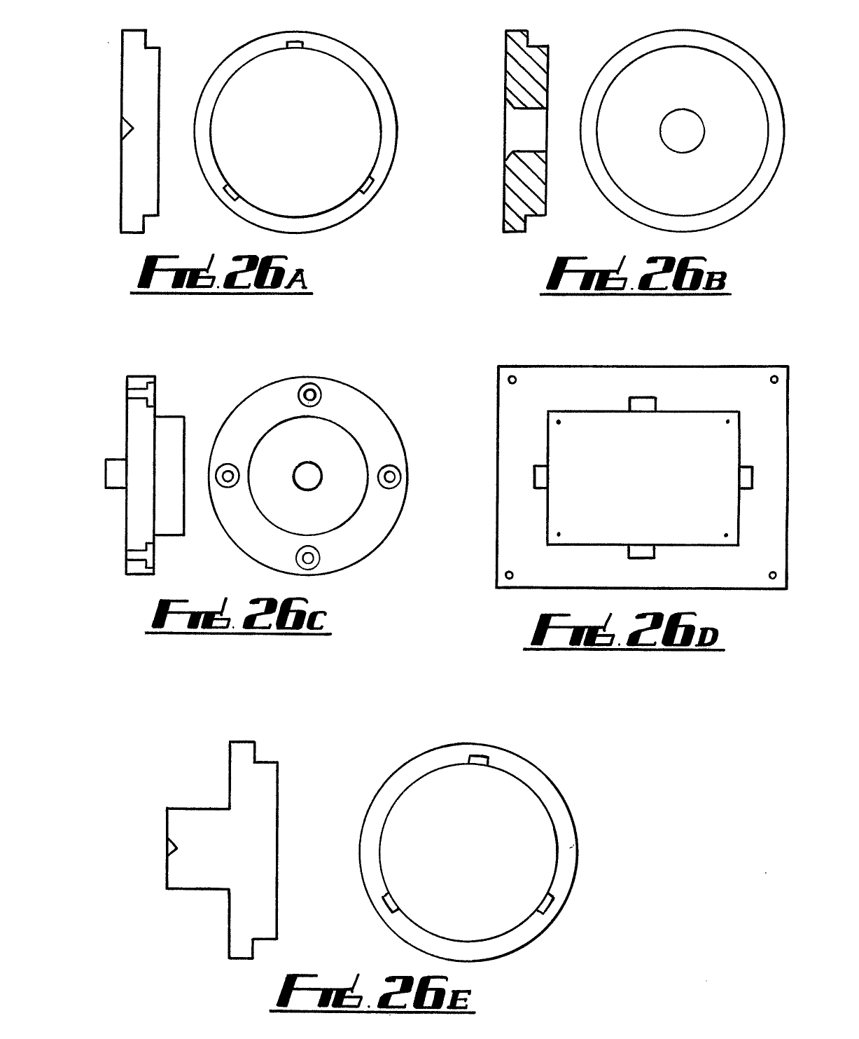

FIGS. 25A and 25B show an embodiment of the present invention in which the mandrel is included; and

FIGS. 26A to 26E show additional embodiments of the present invention.

FIGS. 4A and 4B show the general arrangement of a first embodiment of the present invention. The apparatus consists of a back plate 39 connectable to a mounting 63 in which a drive mechanism is contained. The drive mechanism consists of a cog 53 coupleable to a drive gear 43. The drive gear is mounted on a shaft 45 which has a tapered end 47 containing a drive coupler recess 55. The tapered end 47 is shaped to fit in a recess 49 such that when in place the drive gear cannot be rotated. The other end of the shaft forms an abutment which fits into a recess 41 in the back plate 39.

The cam 65 is rotatable about the point 40 and upon rotation of the drive gear 43 the cam is caused to rotate and the cam follower 69 is moved up the slope of the cam thereby causing radial outwards movement of the key or support member 61. Therefore, as the camwheel 62 is rotated in one direction, the keys 61 ride up the cam generating an increasing inscribed diameter until end stops make contact with the keys. When the camwheel 62 rotation is reversed, the inscribed diameter will decrease until the end stops make contact with the keys.

The cam profile is determined by the expansion distance required to suit the application. As the cam sections are identical, all external forces, pressures, loads applied through the keys are distributed evenly thus ensuring the support plate remains central to the component. Typically expansion distances give 4 mm-10 mm diametrical difference. The contact edge of the keys are machined to the smallest inscribed diameter thus ensuring a single point of contact with the component reducing surface damage (FIG. 7).

The keys are retained and retracted by either a torsion coil spring 77 (FIGS. 8A and 8B), or a leaf type spring 83 (FIG. 9), whose action locates the keys against the camwheel. The retaining springs are located in slots in the main body and the keys which also have a retaining pocket 79 to position the springs centrally (FIGS. 8A and 8B). The back plate 39 which is bolted to the main body retains the springs in position.

In this embodiment, the standard keys/support members are manufactured from a high quality steel to prevent wear and distortion. Alternatively, they can be supplied hardened with ground finish. Keys can be made from other materials e.g. nylon, plastic, brass. Another enhancement is to coat the contact point of keys with a separate material e.g. rubber, cardboard. This is an important feature when contamination of materials is a concern.

In the spur gear arrangement (FIG. 4A and 4B) the adjustment is effected by rotating the driver gear spindle through an internal hexagon shaped coupler attachable to a standard allen key. Locking is affected by the end taper section 47 of the driver gear spindle or shaft 45 being engaged to the tapered hole 49 with compression spring 51 forcing engagement of tapers with the back plate retaining the compression spring.

In the spur gear arrangement (FIG. 4A and 4B) the adjustment is effected by rotating the driver gear spindle/shaft 45 through an internal hexagon/drive coupler 55 using a standard allen key. Locking is effected by the end taper section of the driver gear spindle 47 being engaged to the tapered hole in the main/support body 63 with compression spring 51 forcing engagement of tapers 47, 49 with the back plate retaining the compression spring 51.

When adjusting the driver gear spindle or shaft 45, the allen key (not shown) must be pushed inwards to separate the tapers 47, 49 before rotating is possible. This failsafe arrangement protects against any accidental adjustment and retains unit to component, especially important during loading or unloading to machine tools.

The back plate function to compress the spring 51 on driver gear spindle, to retain torsion or leaf springs, keys and to act as a central axle for the camwheel 62 and drive gear 43. The drive gear 43 is attached to the camwheel 62 by means of fitted taper pins to eliminate backlash or alternatively, manufactured as a single component.

For heavy vibration applications, a commercially available pressure wave type washer is located on a circular groove on the back plate (89 FIG. 10), whose action works on the cam and gear assembly against the main body to dampen the movement of the cam and gear assembly.

Another enhancement is the fitting of commercially available anti-backlash spur and worm gear assemblies for high specification applications to eliminate any movement between the gear teeth. Another enhancement, (FIG. 11), shows a grub screw 85 fitted to the main body which locates in a radial groove on the spur or worm gear to lock the cam and gear assembly against the back plate, which provides a rigid lock on the whole assembly.

In addition, when machining a long thin wall circular tube on a lathe, a support lathe with a parallel outside diameter (FIG. 12) can be inserted inside the tube to reduce vibration and aid component rigidity to improve surface finish and reduce machining time.

A feature to enhance gripping and alignment of the component relative to the support plate, is for the keys to take the form of the component. FIGS. 13 and 14 show one key with a radial taper and another key with a tapped hole to accept a location pin as examples. This feature is important in fixtures where the component is gripped and located simultaneously.

FIGS. 15A and 15B show a wormwheel drive arrangement 95 of the device incorporated in the main body 63. All other parts and functions operate in a similar manner to those shown in FIGS. 4a and 4B. By varying the number of teeth on the wormwheel 95 and using multi-start threads on the worm, finer adjustment of gripping loads can be achieved. In addition, commercially available torque wrenches can be used on nut 97 to adjust preset values to allow consistent gripping pressures to be applied thereby aiding efficient machining operations and improving safety.

The locking arrangement used in this embodiment is similar to the spur gear arrangement of the previous example. The taper locking is effected by a drive spindle/shaft sliding through the worm fitted with drive keys or splines and a tapered nose section which locates in a tapered hole in the main body. The tapers are engaged by a compression spring located at the rear of the worm gear 95 and retained by the retaining screw. Additionally, locking grub screws are placed against radial grooves on the worm and wormwheel. Adjustment is effected by hexagonal wrenches being pushed inwards and rotated in the required direction, either manually or by mechanical means.

Another cam arrangement (FIGS. 16A and 16B) shows an internal cam assembly 99 with internal cam section pockets 103 in the cam body 101 with a mating cam section 107 or circular pin on the side of the keys. As the cam body 101 is rotated by either the spur or worm gear assemblies, the keys are driven radially generating a change of dimension across the keys dependant on direction of rotation. In this arrangement the arc of the cam section pockets 103 determines the expansion movement with the extremes of the pockets acting as stops when they make contact with the keys.

The internal cam sections also retain and retract keys. FIGS. 21A to 21 C show an integral cams 103, 203 and cam body 101, 201 with cam section pockets being located within the gear 143, 243. This feature is used for slimline configurations of the device in applications where internal space is limited.

Where a specific number of keys are required to suit an application, either a high or odd number and due to restrictions of space, strength or expansion of movement of keys and it is not possible to accommodate the total cam sections on a single cam wheel, multiple camwheels with modified keyends can be utilised. FIGS. 23A to 23C show two camwheels 65, 165 operating six keys with the keyends relieved top and bottom alternately. This allows the keys to slide on their respective cam sections to effect their adjustment and operate in the same manner as the single wheel design. The two camwheels hold their respective angular positions by means of dowel pins and secured to the spur or worm gear assembly. In some applications camwheels and/or gear assemblies are manufactured as a single item.

For odd number applications e.g. the use of 5 keys, is achieved by having 2 cam sections on one wheel, with 3 sections on the other wheel. All cam sections are identical, with the cam sections on two wheels arranged angularly to give equal adjustment to all keys.

FIGS. 24A to 24C show a three tier camwheel with keyends modified. This multiple tiered camwheel is generally used in large diameters requiring extra support, heavy duty applications, reduced vibration, while maintaining concentricity during machining operations. This multiple design usually gives greater expansion movement due to the increase in surface area available for cam sections.

FIGS. 17 to 20 show some additional embodiments of the present invention having multiple cam wheels.

A mandrel is a known workholding device used to hold a component while performing an engineering function e.g. machining, assembly, cleaning, etc. Mandrels are normally used for components that are fragile, high precision or with special requirements which normal methods of workholding are inappropriate. Typically, a worn chuck on a lathe which does not hold a component true to it's turning axis, or causes distortion to the component, etc.

FIGS. 25A and 25B show a type of mandrel being used in conjunction with an embodiment of the present invention. The chuck jaws 113 grip the mandrel 112 and the endplate 115 supports the main body 117 and a fulcrum for the axle 119. The main body 117 houses the wormwheel and gear assembly 121 which supplies the rotational movement. The backplate 123 is bolted to the mainbody and supports the axle 118. The cam arrangement 125 is mounted and secured to the axle 118. This embodiment shows two units of two tier camwheels 131 mounted in tandem with their cam sections in the same angular plane to ensure keys 129 move radially in a parallel plane to the axle. The keys 129 bridge the two tandem camwheels 131 with the keyends relieved to allow rotation of the cams. Circular grooves are cut on the circumference of the main body 117 and slots 127 on the outer edge of the keys to local circlips to retain and retract the keys. Any number of tandem camwheels and/or keys can be used dependent on applications.

The worm gear assembly provides the gripping and clamping action, the multiple cam arrangement shown FIGS. 25A and 25B which shows two or more camwheels used in tandem, to provide the expansion movement. This configuration gives a long and wide clamping area and provision for any number of keys.

FIGS. 26A to 26E shows some adaptations of the invention. These figures illustrate how different material sections can be gripped and clamped, central to the material section, making it ideal for use in manufacturing fixtures where repeatability of a component's physical position relative to the support plate is a critical factor to allow efficient machining or other applications.

FIG. 26A shows a solid expandable support plate with a conical centre to suit tailstock applications. FIG. 26B shows a hollow type expandable support plate with a conical centre for tailstocks, and is ideal for end plates on fixtures, to clamp and centralise components. FIG. 26C shows an expandable support plate with a rear location spigot for assembly into fixtures. The constant spigot diameter allows interchange between different styles and sizes of the expandable support plates. FIG. 26D shows a rectangular expandable support plate operated by two sets of different length keys, and by a single or two tier camwheel normally expanded by the wormwheel arrangement. FIG. 26E shows a solid expandable support plate with an extended length centre which allows better access in tailstock area of a centre lathe or milling machine.

The present invention has a number of key features and advantages with respect to the prior art.
1. No radial displacement of keys occurs under load.
2. The invention has a failsafe lock feature in which an adjustment screw requires to be unlocked before adjustment.
3. Compact Design: the invention can be manufactured from lightweight materials and is similar in size to conventional support plates.
4. Keys can be made or coated with different materials where metal contamination is an issue.
5. Compact Storage: reduced storage space required.
6. Safety: No sharp features for swarf entrapment. Expandable plate will not fall or slip when component is being loaded/unloaded.
7. The invention alters the natural frequencies to reduce vibration.
8. Design can be incorporated for different material sections e.g. square, round, triangular, etc.
9. Any number of keys can be incorporated to give wide range of applications.
10. Choice of angular plane for effecting adjustment.
11. Design can be incorporated in a variety of configurations, e.g. circular, triangular, square, allowing incorporation to existing fixtures as an application example.
12. Using calibrated torque wrenches, gripping forces can be controlled to suit individual specific applications.
13. Equal loading spread across the cam arrangement ensures component remains central to support plate.
14. The external area of the keys can take the form of the component to enhance gripping and alignment of component relative to the support plate by means of tapers, recesses, location pins, and location holes for example.
15. Clamping area can be increased by using the mandrel configuration to reduce distortion of component or conversely increase gripping loads.
   Improvements and modifications may be incorporated herein without deviating from the scope of the invention.

1. A support apparatus for supporting a hollow part of a component being machined, the support apparatus comprising: a mounting; at least one support member connectable with a surface to be supported; and an actuator for moving the at least one support member in a substantially radial direction with respect to a centre point on the support member to allow radial extension and contraction of the at least one support member.

2. A support apparatus as described in claim 1, wherein the actuator and the support member are contactable by a cam and a cam follower.

3. A support apparatus as described in claim 1, wherein the actuator comprises a rotably mounted member having a cam surface contactable with a cam follower surface on the support member.

4. A support apparatus as described in claim 3, wherein the cam surface is situated on the perimeter surface of the rotatably mounted member.

5. A support apparatus as described in claim 3, wherein the cam surface is provided by a recess in the rotatably mounted member.

6. A support apparatus as described in claim 1, wherein the actuator is provided with gear cogs which are couplable to a drive gear.

7. A support apparatus as described in claim 6, wherein the drive gear is a worm gear.

8. A support apparatus as described in claim 6, wherein the drive gear is a spur gear.

9. A support apparatus as described in claim 6, wherein the drive gear is removably couplable to the gear cogs.

10. A support apparatus as described in claim 6, wherein the amount of radial extension of the support member can be set by providing locking means to inhibit the rotation of the drive gear when coupled to the gear cogs of the actuator.

11. A support apparatus as described in claim 6, wherein the drive gear is mounted on a shaft between resilient means and a tapered end part.

12. A support apparatus as described in claim 11, wherein the tapered end part is mateable with a recess in the mounting, such that when mated, rotation of the drive gear is inhibited.

13. A support apparatus as described in claim 11, wherein the resilient means forms a release mechanism to allow the drive gear to be rotated upon compression of the resilient means.

14. A support apparatus as described in claim 1, wherein the support member comprises a back plate and an actuator support.

15. A support apparatus as described in claim 14, wherein the back plate is provided with vibration damping means.

16. A support apparatus as described in claim 15, wherein the vibration damping means is provided by a pressure wave washer.

17. A support apparatus as described in claim 14, wherein the back plate is provided with a recess for receiving the resilient means mounted on the shaft.

18. A support apparatus as described in claim 1, wherein the support member is spring loaded to press against the surface to be supported.

19. A support apparatus as described in claim 18, wherein the spring is a leaf spring.

20. A support apparatus as described in claim 18, wherein the spring is a coil spring.

21. A support apparatus as described in claim 1, wherein the support member is provided with a support surface shaped to conform with the surface to be supported.

22. A support apparatus as described in claim 1, wherein the support surface is tapered.

23. A support apparatus as described in claim 1, wherein the support surface is provided with a tapered hole.

24. A support apparatus as described in claim 1, wherein the support surface is curved so as to contact the surface to be supported at a single point.

25. A support apparatus as described in claim 1, wherein the support apparatus is further provided with a plurality of actuator mounting and support members arranging axially with respect to one another, and each having at least one support member.
